(19) United States
(12) Patent Application Publication
(10) Pub. No.: US 2019/0074121 A1
(43) Pub. Date: Mar. 7, 2019

(54) MAGNETS COMPRISING A COATING INCLUDING AN ALUMINUM LAYER

(71) Applicant: Xtalic Corporation, Marlborough, MA (US)

(72) Inventors: Samuel R. Cross, Cambridge, MA (US); Robert D. Hilty, Walpole, MA (US); Anne L. Testoni, Bolton, MA (US); John Cahalen, Arlington, MA (US)

(73) Assignee: Xtalic Corporation, Marlborough, MA (US)

(21) Appl. No.: 16/029,825

(22) Filed: Jul. 9, 2018

Related U.S. Application Data
(60) Provisional application No. 62/530,791, filed on Jul. 10, 2017.

(51) Int. Cl. H01F 7/02; H01F 1/147; C25D 3/44

(52) U.S. Cl. CPC H01F 7/0221; C25D 3/44; H01F 1/14708

(57) ABSTRACT

Magnets including a coating and related methods are described herein. The coating may include an aluminum layer. The aluminum layer may be formed in an electroplating process.

### FIELD OF INVENTION

The present invention generally relates to magnets comprising a coating including an aluminum layer and related methods (e.g., electroplating methods).

### BACKGROUND OF INVENTION

Magnets are used in numerous applications. Some magnetic materials (e.g., rare earth magnetic materials) are prone to corrosion and/or brittleness when used in certain applications. Such corrosion and/or brittleness can negatively impact their performance and efficacy. Accordingly, technical solutions that can mitigate the corrosion and brittleness problems associated with such magnets are desirable.

### SUMMARY OF INVENTION

Magnets including a coating and related methods are described herein.

In one aspect, an article is provided. The article comprises a magnet and an electroplated coating formed on the magnet. The coating includes an aluminum layer.

In another aspect, a method is provided. The method includes electroplating a coating on a magnet. The coating includes an aluminum layer.

Other aspects, embodiments, and features of the invention will become apparent from the following detailed description. All patent applications and patents incorporated herein by reference are incorporated by reference in their entirety. In case of conflict, the present specification, including definitions, will control.

### DETAILED DESCRIPTION

Magnets including a coating and related methods are described herein. As described further below, the coating may include an aluminum layer. In some embodiments, the coating may include other layers including one or more other aluminum layer(s), aluminum alloy layers or other types of layers (e.g., intervening layers). The aluminum layer (and/or other layer(s) of the coating) may be formed in an electroplating process (e.g., a barrel electroplating process). In some embodiments, the magnets comprise rare earth magnetic material (e.g., NdFeB-based materials). The coated magnets may be used in a variety of applications including in portable electronic devices. The coatings impart the magnets with desirable properties including corrosion resistance and ductility.

In general, the magnet may comprise any suitable magnetic material. Magnetic materials that are prone to corrosion and/or brittleness may be particularly well-suited for use in the embodiments described herein. In some cases, the magnet comprises a rare earth magnetic material. For example, the rare earth magnetic material may comprise neodymium; and, in some cases, the rare earth magnetic material further comprises iron and boron, in addition to neodymium. For instance, the rare earth magnetic material may be a NdFeB-based material such as Nd₂Fe₁₄B and Nd₉Fe₈₆B₅. Other rare earth magnetic materials are also suitable including SmCo₅, AlNiCo, and NiFe, amongst others. In some embodiments, the magnetic material may not be a rare earth magnetic material. For example, the magnetic material may be an AlNiCo material (e.g., comprising Al (8-12 atomic %), Ni (15-16 atomic %), Co (5-24 atomic %), Cu (<6 atomic %), Ti (<1 atomic %), balance Fe) or a NiFe material (e.g., materials having a L10 crystal structure, 50 at % Fe-50 at % Ni).

The magnet may have a variety of different shapes and sizes. For instance, the magnet may be a block, a ring or a cylinder. The magnets may have dimensions (i.e., length, thickness, width) on the order of millimeters or centimeters (e.g., greater than 0.1 mm such as 0.1 mm to 100 cm). It should be understood that other shapes and dimensions may be suitable and the specific shape and dimensions may depend, in part, on the application in which the magnet is used.

As noted above, the techniques described herein involve coating the magnet. The coating may include only one layer (i.e., the aluminum layer). In other embodiments, the coating may include multiple layers, as described further below. In some cases, the coating may be formed on at least a portion of the outer surface of the magnet. In other cases, the coating covers the entire outer surface of the magnet.

When a layer is referred to as being “on,” “over,” or “overlying” another structure (e.g., magnet, another layer), it can be directly on the structure, or an intervening structure (e.g., another layer) also may be present. A layer that is “directly on” or “in direct contact with” another structure means that no intervening structure (e.g., another layer) is present. It should also be understood that when a structure is referred to as being “on” or “over” another structure, it may cover the entire structure, or a portion of the structure.

In some embodiments, the coating includes an aluminum layer. As used herein, an aluminum layer refers to a layer that comprises greater than 98% by weight aluminum. For example, the aluminum layer may be greater than 99% by weight aluminum, greater than 99.5% by weight aluminum, and greater than 99.9% by weight aluminum. The aluminum may be a non-alloy (i.e., pure metal) layer. In some embodiments, the aluminum layer is crystalline and non-amorphous. As described further below, the aluminum layer may be an electroplated layer which could be identified by one of ordinary skill in the art.

The coating and aluminum layer may have any suitable thickness. In some embodiments, it may be advantageous for a layer to be thin, for example, to save on material costs. In some embodiments, it may be advantageous for a layer to be thick, for example, to produce high quality coatings that impart the coated magnets with enhanced corrosion resistance and ductility. For example, the coating and/or layer thickness may be less than 50 microns (e.g., between about 1 micron and about 50 microns; in some cases between about 5 microns and about 50 microns; in some cases between about 10 microns and about 50 microns; in some cases between about 20 microns and about 50 microns; in some cases between about 30 microns and 50 microns; in some cases between about 40 microns and 50 microns). In some embodiments, the coating and/or layer thickness may be greater than 1 micron (e.g., between about 1 microns and about 50 microns; in some cases, between about 2 microns and about 50 micros; in some cases, between about 5 microns and about 50 micros; in some cases between 10 microns and 50 microns; in some cases between 20 microns and 50 microns; in some cases between 30 microns and 50 microns, or in some cases between 40 microns and 50 microns). It should be understood that other layer thicknesses may also be suitable.

As noted above, the coating may include additional layers. In some embodiments, the coating may include multiple aluminum layers. For example, in certain embodiments, there are three layers of aluminum. The multiple aluminum layers may be distinguishable from each other based on the plating processes, which cause a disruption to the growth of the gains in the layer, as described in more detail below.

The coating and/or layer thickness of the multiple aluminum layer coatings may have any suitable thickness. For example, the coating and/or layer thickness of each layer may be less than 50 microns (e.g., between about 1 micron and about 50 microns; in some cases between about 5 microns and about 50 microns; in some cases between about 10 microns and about 50 microns; in some cases between about 20 microns and about 50 microns; in some cases between about 30 microns and 50 microns; in some cases between about 40 microns and 50 microns). In some embodiments, the coating and/or layer thickness of each layer may be greater than 1 micron (e.g., between about 1 microns and about 50 microns; in some cases, between about 2 microns and about 50micros; in some cases, between about 5 microns and about 50 micros; in some cases between 10 microns and 50 microns; in some cases between 20 microns and 50 microns; in some cases between 30 microns and 50 microns, or in some cases between 40 microns and 50 microns). It should be understood that other layer thicknesses of each layer may also be suitable.

In certain embodiments, the coating may include a layer of metal alloy on the aluminum layer. According to some embodiments, the coating may include an aluminum layer on the metal alloy layer. In some embodiments, the metal alloy layer may be an aluminum alloy layer. In certain embodiments, the aluminum alloy layer is an aluminum manganese alloy layer. In certain embodiments, the aluminum alloy is aluminum manganese alloy with ˜5 atomic % manganese. In certain embodiments, the aluminum alloy is aluminum zirconium alloy. In certain embodiments, the aluminum alloy is aluminum chromium alloy. According to some embodiments, the aluminum alloy is aluminum hafnium alloy. In certain embodiments, the aluminum alloy is aluminum nickel alloy. According to certain embodiments, the aluminum alloy is aluminum cobalt alloy.

The coating and/or layer thickness of the metal alloy layer coating may have any suitable thickness. For example, the coating and/or layer thickness of the metal alloy layer may be less than 50 microns (e.g., between about 1 micron and about 50 microns; in some cases between about 5 microns and about 50 microns; in some cases between about 10 microns and about 50 microns; in some cases between about 20 microns and about 50 microns; in some cases between about 30 microns and 50 microns; in some cases between about 40 microns and 50 microns). In some embodiments, the coating and/or layer thickness of the metal alloy layer may be greater than 1 micron (e.g., between about 1 microns and about 50 microns; in some cases, between about 2 microns and about 50 micros; in some cases, between about 5 microns and about 50 micros in some cases between 10 microns and 50 microns; in some cases between 20 microns and 50 microns; in some cases between 30 microns and 50 microns, or in some cases between 40 microns and 50 microns). It should be understood that other layer thicknesses may also be suitable.

According to certain embodiments, the coating may include an intervening layer between the magnet and the aluminum layer and/or between the aluminum layer and another layer of the coating such as the metal alloy layer. In some cases, the intervening layer may be nickel. According to some embodiments, the intervening layer may be a nickel alloy (e.g., nickel-tungsten alloy). According to certain embodiments, the nickel based intervening layer could be plated from a nickel sulfamate plating bath.

The coating and/or layer thickness of the intervening layer coating may have any suitable thickness. For example, the coating and/or layer thickness of the intervening layer may be less than 50 (e.g., between about 1 micron and about 50 microns; in some cases between about 5 microns and about 50 microns; in some cases between about 10 microns and about 50 microns; in some cases between about 20 microns and about 50 microns; in some cases between about 30 microns and 50 microns; in some cases between about 40 microns and 50 microns). In some embodiments, the coating and/or layer thickness of the intervening layer may be greater than 1 (e.g., between about 1 microns and about 50 microns; in some cases, between about 2 microns and about 50 micros; in some cases, between about 5 microns and about 50 micros in some cases between 10 microns and 50 microns; in some cases between 20 microns and 50 microns; in some cases between 30 microns and 50 microns, or in some cases between 40 microns and 50 microns). It should be understood that other layer thicknesses may also be suitable.

As noted above, layer(s) of the coating may be formed using an electrodeposition (also referred to as an electroplating process). In some cases, each layer of the coating may be applied using a separate electrodeposition bath. In general, during an electrodeposition process an electrical potential may exist on the substrate to be coated, and changes in applied voltage, current, or current density may result in changes to the electrical potential on the substrate. In some cases, the electrodeposition process may include the use of waveforms comprising one or more segments, wherein each segment involves a particular set of electrodeposition conditions (e.g., current density, current duration, electrodeposition bath temperature, etc.). The waveform may have any shape, including square waveforms, non-square waveforms of arbitrary shape, and the like. In some methods, such as when forming coatings having different portions, the waveform may have different segments used to form the different portions. However, it should be understood that not all methods use waveforms having different segments.

In some embodiments, a coating, or portion thereof, may be electrodeposited using direct current (DC) deposition. For example, a constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the layer(s) may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of composition of the coating that is produced.

Those of ordinary skill in the art would recognize that the electrodeposition processes described herein are distinguishable from electroless processes which primarily, or entirely, use chemical reducing agents to deposit the coating, rather than an applied voltage. The electrodeposition baths described herein may be substantially free of chemical reducing agents that would deposit coatings, for example, in the absence of an applied voltage. In some embodiments, a barrel electroplating process is used to deposit one or more layer(s) of the coating (e.g., the aluminum layer and the aluminum alloy layer). In general, the barrel plating processes described herein involve loading many small magnets to be coated into a barrel. The barrel plating apparatus is configured such that the magnets are in contact with an electroplating bath. As described further below, the bath includes appropriate chemical species including metal ionic species (e.g., aluminum ionic species) which are deposited in the form of an alloy (e.g., aluminum) during the plating process. In some cases, the barrel is placed in the bath (which may be contained in a tank) and perforations in the barrel walls enable the bath to contact the components.

Within the barrel, the magnets are in electrical contact with one or more other components. An electrical lead (also referred to as a “dangler”) extends within the volume of the barrel and contacts at least some the magnets during use. The lead is connected to a power supply so that it can function as a “barrel” electrode used in the electrodeposition process to provide electrical current to the magnets. The electrical lead, also referred to as a “dangler”, can be a conductive wire such as a metal wire, or a series of metal wires in electrical contact with one another. The electrical lead can also be a conductive rod or other geometry of conductive material, or an assembly of many such geometries. In some cases, functional geometries are part of the electrical lead as in the case of mechanical clips, clamps, screws, hooks, or brushes which facilitate electrical contact with components. The electrical lead need not be stationary, but can move due to the agitation of the process. For example, the electrical lead can be coupled to the barrel.

The barrel coating apparatus can include a “bath” electrode which is in contact with the electroplating bath. For example, the bath electrode may be immersed in the bath. During plating, a voltage is applied between the barrel and bath electrodes using the power supply. The electrical current passes from the power supply through the barrel electrode, and into the magnets with which it is in contact and to the other magnets in the barrel via the physical contacts between the magnets. As the barrel rotates or vibrates, a substantial portion of the magnets are in contact with one another and, thus, function as a single electrode. As a result of the potential on the magnets, metal ionic species (e.g., aluminum ionic species) in the bath are reduced on the magnet surfaces and deposit in the form of a layer on the magnets. In some embodiments, magnets are loaded into the barrel along with additional plating media. The media may be of any desired shape. In some embodiments, the media are metallic and may be plated at the same time as the magnets.

In general, the baths include suitable metal sources for depositing a layer with the desired composition. For instance, when depositing a metal alloy, it should be understood that all of the metal constituents in the alloy have sources in the bath. The metal sources are generally ionic species that are dissolved in the fluid carrier. As described above, during the electrodeposition process, the ionic species are deposited in the form of a metal alloy to form the coating. In general, any suitable ionic species can be used. In some embodiments, electrodeposition bath comprising aluminum ionic species, an ionic liquid, and at least one type of additive. In some embodiments, the electrodeposition bath comprises an organic co-solvent. The organic co-solvent may be used to reduce the viscosity of the ionic liquid electrolyte, improve the conductivity of the ionic liquid electrolyte, improve electrodeposition rates, improve the deposit appearance, and/or reduce dendritic growth.

According to some embodiments, another method of applying the aluminum layer(s) includes halting the plating process as the parts are removed from the electrolyte (i.e., bath) and tumbled in a dry nitrogen environment. The parts remain in a barrel and then are returned to the electrolyte for an additional aluminum layer. This provides for a 100% electrolyte exchange within the barrel, which may be important in embodiments that utilize ionic liquids which are inherently viscous and have naturally poor fluid transfer during barrel plating. In some embodiments, the plating process is halted during plating such that adjacent layers are created. In one embodiment, 4 microns of aluminum were plated, followed by a brief pause and tumble, then an additional 4 microns were plated, followed by a pause and tumble, then the last four microns of plating. According to some embodiments, pausing between the plating processes also causes a disruption to the growth of the grains in the layer, producing a layer that is more robust against corrosion.

According to some embodiments, the magnet material can be activated prior to plating with aluminum. Activation of magnets with HCl and/or nitric acid can lead to damage on the surface of the magnet which reduces the total magnetic flux in the magnet. Activating with ionic liquid, e.g., which has been treated with an acidifying compound to form an acidified ionic liquid, can provide an active surface with less loss in magnetic flux. For example, suitable processes for treating ionic liquids have been described in U.S. Pat. No. 9,752,242 which is incorporated herein by reference in its entirety. Compounds which provide residual hydrogen ions in solution are considered acidifying compounds. Examples of these compounds include water, HCl, HBr, HI, silica, alumina, cellulose and hydroxyls. The activation process can occur electrolytically or without applied current.

Magnets plated with aluminum and aluminum alloys can have attractive appearance and surface finish. One skilled in the art can modify the plating parameters described here to produce coatings which are matte, bright or satin in appearance. In some embodiments, magnets are treated after plating to improve their appearance and remove staining. In some embodiments, magnets are washed after plating in an acidic cleaning solution (e.g., solution of 10% phosphoric acid) then rinsed in water. In some embodiments oxalic acid is used as the cleaning solution. Other oxidizing acids may be also used.

In some embodiments, the corrosion performance and appearance of the aluminum plated magnet can be improved by converting all or part of the aluminum layer using anodization. The resulting anodized layer can be a layer on top of one or more of the aluminum or aluminum alloy layers. In some embodiments, the anodizing process consumes all of the aluminum plating. After anodization, a dye colorant may be applied to provide a desired color to the layer. The anodization layer can be sealed using organic surface treatments or with hot water.

Those of ordinary skill in the art would be able to select the appropriate combination of bath components suitable for use in a particular application. Generally, the additives in a bath are compatible with electrodeposition processes, i.e., a bath may be suitable for electrodeposition processes.

As noted above, the coated magnets have desirable properties including corrosion resistance. In some embodiments, the invention provides coated articles that are capable of resisting corrosion, and/or protecting an underlying substrate material from corrosion, in one or more potential corrosive environments. Examples of such corrosive environments include, but are not limited to, aqueous solutions, acid solutions, alkaline or basic solutions, or combinations thereof. For example, coated articles described herein may be resistant to corrosion upon exposure to (e.g., contact with, immersion within, etc.) a corrosive environment, such as a corrosive liquid, vapor, or humid environment.

The corrosion resistance may be assessed using test standards such as ASTM B117 (Neutral Salt Spray), which tests relative corrosion resistance for specimens of metals and coated metals exposed in a standardized corrosive environment.

The coated magnets descried herein may exhibit outstanding corrosion performance. For example, following the protocol in ASTM B117, the coated magnets can survive greater than 100 hours of salt spray exposure, greater than 200 hours of salt spray exposure, greater than 400 hours of salt spray exposure, greater than 500 hours of salt spray exposure, greater than 700 hours of salt spray exposure, greater than 800 hours of salt spray exposure and/or greater than 1000 hours of salt spray exposure.

Sample parts with the various coatings can also be tested for porosity and corrosion resistance using an acid vapor test method. ASTM B735 is well known in the art for measuring the porosity of gold plated parts. A similar test method was created to test porosity of Al layer(s) on magnets. Samples of magnets were places on a Teflon carrier which was suspended over a 50 ml solution of acetic acid sealed in a 1 liter jar. The acid solution was made by dispensing 48 microliters of acetic acid into 1 liter of water. After parts were placed in the jar with the acid solution, the jar was sealed and placed in an oven at 75° C. The test was continued until red rust formed and was visible due to magnet corrosion.

The coated magnets described herein can exhibit outstanding corrosion performance. For example, following the protocol based on ASTM B735 as described above, the coated magnet can survive greater than 100 hours of acetic acid exposure, greater than 200 hours of acetic acid exposure, greater than 300 hours of acetic acid exposure, greater than 400 hours of acetic acid exposure, greater than 500 hours of acetic acid exposure, greater than 300 hours of acetic acid exposure, greater than 600 hours of acetic acid exposure, greater than 700 hours of acetic acid exposure, greater than 800 hours of acetic acid exposure, greater than 900 hours of acetic acid exposure and/or greater than 1000 hours of acetic acid exposure.

Magnets plated with aluminum or aluminum layers can exhibit good performance in nickel leaching corrosion tests. This can be particularly helpful for magnets which contact the skin as some people can experience nickel dermatitis. Magnets plated with aluminum layers as described here perform well in nickel leach tests, such as DIN EN1811.

Also as noted above, the coated magnets have ductility properties enabling the coated magnets to have good thermal shock resistance and/or thermal cycling without cracking. The coated magnets may be used in a variety of applications including, but not limited to, portable electronic devices, head actuators for computer hard disks, magnetic resonance imaging (MRI), magnetic guitar pickups, loudspeakers and headphones, magnetic bearings and couplings, permanent magnet motors, cordless tools, servo motors, lifting and compressor motors, synchronous motors, spindle and stepper motors, electrical power steering, drive motors for hybrid and electric vehicles, actuators, and magnetic clasps.

What is claimed:

1. An article, comprising:
a magnet; and
an electroplated coating formed on the magnet, the coating including an aluminum layer.

2. A method of forming an article comprising:
electroplating a coating on a magnet, the coating including an aluminum layer.

3. The article of claim 1, wherein the magnet comprises a rare earth magnetic material.

4. The article of claim 1, wherein the magnet comprises neodymium.

5. The article of claim 1, wherein the magnet further comprises iron and boron.

6. The article of claim 1, wherein the magnet comprises a material selected from the group consisting of Nd₂Fe₁₄B, Nd₉Fe₈₆B₅, SmCo₅, AlNiCo, and NiFe.

7. The article of claim 1, wherein the coating includes a single layer.

8. The article of claim 1, wherein the coating includes multiple layers.

9. The article of claim 1, wherein the coating includes three layers, the three layers comprising aluminum.

10. The article of claim 1, wherein one or more of the multiple layers comprises aluminum.

11. article of claim 1, wherein one or more of the multiple layers comprises an aluminum alloy.

12. The article of claim 1, wherein one or more of the multiple layers comprises anodized aluminum.

13. The article of claim 1, wherein one or more of the multiple layers comprises an aluminum alloy.

14. The article of claim 1, wherein the aluminum alloy layer is on the aluminum layer.

15. The article of claim 1, wherein the aluminum alloy layer is under the aluminum layer.

16. The article of claim 1, wherein the coating comprises an intervening layer between the magnet and aluminum layer or between the aluminum layer and a third layer.

17. The article of claim 1, wherein the intervening layer comprises nickel.

18. The article of claim 1, wherein the intervening layer comprises a nickel alloy.

19. The article of claim 1, wherein the nickel alloy comprises nickel tungsten.

20. The method of claim 2, further comprising:
loading a barrel with a plurality of magnets;
rotating the barrel in an electroplating bath; and
electroplating the coating on the magnets.

21. The method of claim 2, further comprising:
loading a barrel with a plurality of magnets;
vibrating the barrel in an electroplating bath; and
electroplating the coating on the magnets.

22. The method of claim 2, further comprising:
preparing the magnets for plating by activating the magnets with an acidified ionic liquid.
